(19) United States
(12) Patent Application Publication
(10) Pub. No.: US 2018/0142613 A1
(43) Pub. Date: May 24, 2018

(54) CONTROL DEVICE FOR AN INTERNAL COMBUSTION ENGINE

(71) Applicant: Honda Motor Co.,Ltd., Tokyo (JP)

(72) Inventor: Atsushi KURAUCHI, Saitama (JP)

(73) Assignee: Honda Motor Co.,Ltd., Tokyo (JP)

(21) Appl. No.: 15/796,862

(22) Filed: Oct. 30, 2017

(30) Foreign Application Priority Data
Nov. 22, 2016 (JP) 2016-226938

(51) Int. Cl. F02B 37/18; B60W 20/40

(52) U.S. Cl. CPC F02B 37/183; B60W 2710/0638; B60W 20/40

(57) ABSTRACT

According to the present invention, there is provided a control device for an internal combustion engine which includes a motor driving a WG valve (waste gate valve), and in which a target opening degree of the WG valve is set in accordance with a running state of an internal combustion engine and a valve opening degree of the WG valve is controlled by controlling electrification of the motor. While the internal combustion engine is starting or is running with the target opening degree set to a fully-closed opening degree, an electrification duty ratio of the motor is controlled such that the electrification duty ratio meets a predetermined value allowing the WG valve to be pressed to a fully-closed position, and electrification of the motor stops after the WG valve is driven to the fully-closed position while the internal combustion engine is in a stop state.

### CROSS-REFERENCE TO RELATED APPLICATION

This application claims the priority benefit of Japan application serial no. 2016-226938, filed on Nov. 22, 2016. The entirety of the above-mentioned patent application is hereby incorporated by reference herein and made a part of this specification.

### BACKGROUND OF THE INVENTION

### Field of the Invention

The present invention relates to a control device for an internal combustion engine having a waste gate valve which is provided in a bypass passage bypassing a turbine of a supercharger supercharging intake air and regulates supercharging pressure generated by the supercharger.

### Description of Related Art

Patent Document 1 discloses a control device for an internal combustion engine as an example of known control devices in the related art. The internal combustion engine is mounted in a vehicle as a driving source and includes a waste gate valve including an electric actuator. In this vehicle, idling stop control for automatically stopping the internal combustion engine is executed when predetermined automatic stop conditions are satisfied. In addition, in this control device, when the internal combustion engine is automatically stopped, fuel stops being supplied from a fuel injection valve, the waste gate valve is then closed by means of electrification of an actuator and the valve closed state of the waste gate valve is maintained while the internal combustion engine is at an automatic stop until restart conditions are satisfied.

### PRIOR ART DOCUMENT

### Patent Documents

[Patent Document 1] Japanese Unexamined Patent Application Publication No. 2014-227954

### SUMMARY OF THE INVENTION

As in the above-described control devices in the related art, when a waste gate valve is maintained in a valve closed state while an internal combustion engine is at an automatic stop, in order to prevent generation of noise, deterioration of a valve body, and the like caused due to the vibration of the waste gate valve due to the influence of the vibration of the internal combustion engine, and disadvantages caused due to the vibration thereof, for example, a disadvantage in which the waste gate valve comes into contact with (hits) an inner wall of a bypass passage, when the internal combustion engine is restarted after the automatic stop, generally, an electrification amount of an actuator is increased and the waste gate valve is strongly pressed to a fully-closed position. However, in such a case, there is a possibility that not only consumption of electricity will increase but also electromagnetic wave noise will be generated from the actuator.

In order to avoid such disadvantages, for example, when the waste gate valve is controlled such that the waste gate valve is on a side slightly open wider than the fully-closed position while the internal combustion engine is at an automatic stop, there is a need for the waste gate valve to be driven to the fully-closed position when the internal combustion engine is restarted. Accordingly, an increase in supercharging pressure is delayed when sudden acceleration is required after the restart, so that satisfactory acceleration responsiveness cannot be obtained.

Moreover, in a hybrid vehicle in which an electric motor is mounted together with an internal combustion engine, as one of driving modes thereof, an electric motor driving mode in which only the electric motor serves as a driving source is selected. In this electric motor driving mode, when control over opening the waste gate valve from the fully-closed position is employed, there is a possibility that the waste gate valve will vibrate due to the influence of vibration of the traveling vehicle, and noise will be generated due to contact with the inner wall and the like of the bypass passage. Particularly, in the electric motor driving mode, since the internal combustion engine is in a stop state, noise is audible to a driver or persons around the vehicle even when there is relatively little noise, and thus, the market appeal is drastically degraded.

The present invention has been made in order to solve the foregoing problems, and an object thereof is to provide a control device for an internal combustion engine, in which consumption of electricity for driving a waste gate valve is suppressed as much as possible, generation of noise and deterioration of the waste gate valve caused due to contact between the waste gate valve and other members are prevented, and acceleration responsiveness can be improved.

In order to achieve the object, according to the invention of claim 1 in this application, there is provided a control device for an internal combustion engine having a supercharger which supercharges intake air (turbocharger 12 of an embodiment (hereinafter, the same will apply in this application)), and a waste gate valve 14 which is provided in a bypass passage 11 bypassing a turbine 121 of the supercharger and regulates supercharging pressure generated by the supercharger. The control device includes an electric actuator (motor 31) that drives the waste gate valve 14, target opening degree setting unit for setting a target opening degree WGCMD of the waste gate valve 14 in accordance with a running state of an internal combustion engine 1 (ECU 20, Step 5 in FIG. 5), and a control unit for controlling an opening degree of the waste gate valve 14 (valve opening degree WGO) by controlling electrification of the actuator (ECU 20, FIG. 5). The control unit controls an electrification amount of the actuator (electrification duty ratio Iduty) such that the electrification amount meets a predetermined electrification amount (predetermined value IdSTR) allowing the waste gate valve 14 to be pressed to a fully-closed position while the internal combustion engine is starting or in a running state in which the target opening degree WGCMD is set to a fully-closed opening degree (Step 4), and the control unit executes electrification stop control for stopping electrification of the actuator after the waste gate valve 14 is driven to the fully-closed position while the internal combustion engine 1 is in a predetermined stop state (EV mode, idling stop) (Steps 15 and 13).

In this configuration, the opening degree of the waste gate valve is controlled by controlling electrification of the actuator. In addition, while the internal combustion engine is starting or while the internal combustion engine is in the miming state in which the target opening degree of the waste gate valve is set to the fully-closed opening degree, the electrification amount of the actuator is controlled such that the electrification amount meets the predetermined electrification amount allowing the waste gate valve to be pressed to the fully-closed position. Therefore, the waste gate valve is reliably maintained in a state of being pressed to the fully-closed position. Accordingly, the waste gate valve no longer vibrates due to an influence such as vibration of the internal combustion engine during starting or running. As a result, it is possible to prevent generation of noise and deterioration of the waste gate valve and the like caused due to contact between the waste gate valve and other members. In addition, since the waste gate valve is maintained at the fully-closed position, when sudden acceleration is required from this state, the supercharging pressure can be promptly raised, and satisfactory acceleration responsiveness can be ensured. Moreover, it is possible to suppress consumption of electricity to a minimum by causing the predetermined electrification amount of the actuator in this case to be the minimum electrification amount allowing the waste gate valve to be reliably pressed to the fully-closed position.

In addition, in this configuration, the electrification stop control is executed in the predetermined stop state of the internal combustion engine. Therefore, electrification of the actuator stops after the waste gate valve is driven to the fully-closed position. In the stop state, the internal combustion engine does not vibrate. Accordingly, even though electrification of the actuator has stopped after the waste gate valve is driven to the fully-closed position, the waste gate valve is maintained at the fully-closed position. Therefore, even if the internal combustion engine is in a stop state, it is possible to prevent generation of noise and deterioration of the waste gate valve caused due to contact between the waste gate valve and other members. In addition, when sudden acceleration is required from this state, the supercharging pressure can be promptly raised, and satisfactory acceleration responsiveness can be ensured. Moreover, since electrification of the actuator stops and consumption of electricity during that period becomes zero, in addition to suppressing consumption of electricity in the internal combustion engine during starting as described above, it is possible to suppress consumption of electricity as much as possible.

According to the invention of claim 2, in the control device for an internal combustion engine according to claim 1, the internal combustion engine 1 is mounted in a vehicle V to serve as a driving source to together with an electric motor (motor 61), and the vehicle V has an electric motor driving mode (EV mode) in which the internal combustion engine 1 is at a stop and only the electric motor serves as the driving source. The predetermined stop state of the internal combustion engine 1 is a stop state in the electric motor driving mode (Steps 12 and 15).

As described above, in the electric motor driving mode in which only the electric motor serves as the driving source, there is a possibility that the waste gate valve will come into contact with other members due to vibration of the traveling vehicle. Moreover, since the internal combustion engine is at a stop, noise caused due to the contact is audible, and thus, the market appeal is likely to be degraded. In this configuration, since the above-described electrification stop control is executed in the electric motor driving mode, generation of noise caused due to contact of the waste gate valve is prevented. Therefore, it is possible to effectively avoid the aforementioned disadvantage and to improve the market appeal. In addition, since electrification of the actuator has stopped, it is possible to effectively prevent generation of electromagnetic wave noise which is particularly problematic in the electric motor driving mode.

According to the invention of claim 3, the control device for an internal combustion engine according to claim 1 or 2 further includes fully-closed position learning unit for learning the fully-closed position of the waste gate valve 14 after the waste gate valve 14 is driven to the fully-closed position and before electrification of the actuator stops during the electrification stop control (ECU 20, Steps 15, 17, and 13).

In this configuration, since the fully-closed position of the waste gate valve is learned during the electrification stop control by utilizing the timing at which the waste gate valve is driven to the fully-closed position, the learning frequency thereof can be increased. In addition, when sudden acceleration is required from the stop state of the internal combustion engine, the opening degree of the waste gate valve can be controlled by utilizing the fully-closed position which has been learned in the immediately preceding learning, and thus, it is possible to control supercharging pressure with more accuracy.

According to the invention of claim 4, the control device for an internal combustion engine according to any one of claims 1 to 3 further includes actual opening degree detecting unit (valve opening degree sensor 23) for detecting an actual opening degree of the waste gate valve 14 (valve opening degree WGO). The control unit controls the electrification amount of the actuator by means of feedback control such that the detected actual opening degree meets the target opening degree WGCMD (Step 10). The control unit controls the electrification amount of the actuator such that the electrification amount meets a predetermined maximum value IdMAX on a side of opening the waste gate valve 14 by means of feedforward control in place of the feedback control, immediately after a valve opening operation from the fully-closed position of the waste gate valve 14 has begun (Step 9).

In this configuration, the electrification amount of the actuator is controlled by means of the feedback control such that the detected actual opening degree of the waste gate valve meets the target opening degree. When the electrification amount of the actuator is controlled by means of the feedback control as described above, it takes time to input a detection signal of the actual opening degree of the waste gate valve, to calculate feedback correction terms in accordance with the deviation between the target opening degree and the actual opening degree, and to output a drive signal based thereon. Consequently, the operation of the waste gate valve and the response of the supercharging pressure are delayed as according to this time.

In contrast, in this configuration, the electrification amount of the actuator is controlled such that the electrification amount meets the predetermined maximum value on the side of opening the waste gate valve by means of the feedforward control in place of the feedback control, immediately after a valve opening operation from the fully-closed position of the waste gate valve has begun. Accordingly, the response delay in the case of the above-described feedback control is resolved, so that the waste gate valve is driven to the valve open side more promptly and the valve opening time is shortened. As a result, the increased supercharging pressure drops more promptly, and overshooting of the supercharging pressure exceeding the upper limit value is unlikely to occur. Thus, in accordance therewith, greater supercharging pressure can be set as a target and the output of the internal combustion engine can be increased.

### BRIEF DESCRIPTION OF THE DRAWINGS

FIG. 1 is a view schematically illustrating a configuration of a driving device in a vehicle including an internal combustion engine in which the present invention is applied.

FIG. 2 is a view schematically illustrating a configuration of the internal combustion engine.

FIG. 3 is a view schematically illustrating a waste gate valve and a driving mechanism thereof.

FIG. 4 is a block diagram illustrating a configuration of a control device for an internal combustion engine.

FIG. 5 is a flowchart illustrating processing of control over an opening degree of the waste gate valve.

FIG. 6 is a timing chart illustrating an operational example obtained through the processing in FIG. 5.

### DESCRIPTION OF THE EMBODIMENTS

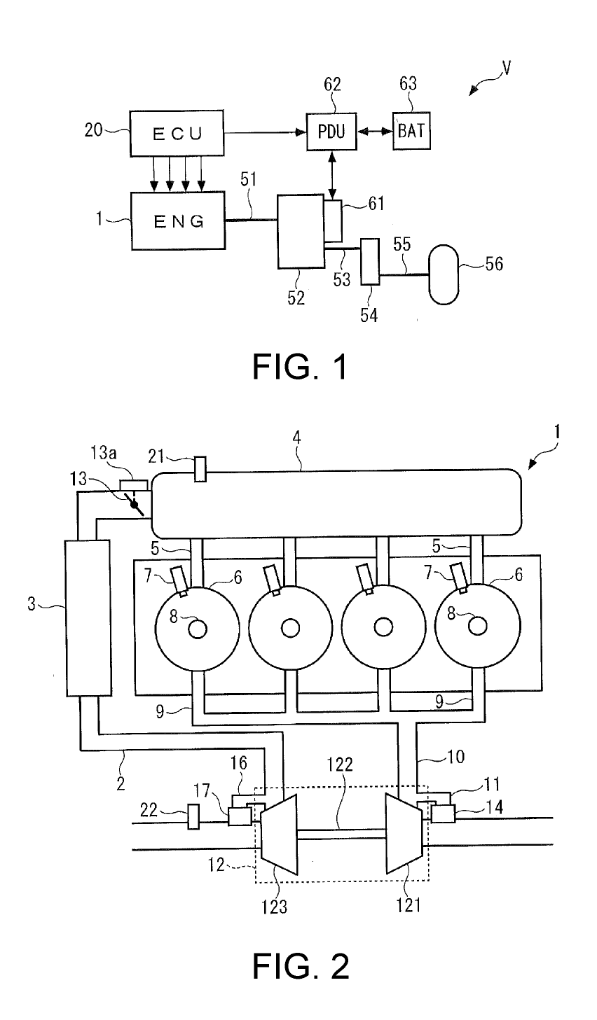

Hereinafter, with reference to the drawings, a preferable embodiment of the present invention will be described in detail. As illustrated in FIG. 1, a vehicle V is a hybrid vehicle including an internal combustion engine (hereinafter, will be referred to as “engine”) 1 which serves as a driving source, and an electric motor (hereinafter, will be referred to as “motor”) 61 which functions as a driving source and a generator. The vehicle V includes a transmission 52 which shifts a driving force of the engine 1 and/or the motor 61.

The motor 61 is connected to a power drive unit (hereinafter, will be referred to as “PDU”) 62, and the PDU 62 is connected to a high-voltage battery 63. When the motor 61 is driven with positive driving torque, that is, when the motor 61 is driven with electricity output from the high-voltage battery 63, the electricity output from the high-voltage battery 63 is supplied to the motor 61 via the PDU 62. In addition, when the motor 61 is driven with negative driving torque, that is, when the motor 61 is subjected to a regenerative operation, electricity generated by the motor 61 is supplied to the high-voltage battery 63 via the PDU 62, thereby charging the high-voltage battery 63.

The PDU 62 is connected to an electronic control unit (hereinafter, will be referred to as “ECU”) 20. Under the control of the ECU 20, the operation of the motor 61 is controlled, and charging and discharging of the high-voltage battery 63 are controlled. The ECU 20 is configured to have an engine control ECU and a motor control ECU (neither is illustrated) which are connected through a communication bus.

The transmission 52 is a so-called dual clutch transmission which is coupled to a crankshaft 51 of the engine 1 via a clutch for odd-number gears and a clutch for even-number gears (neither are illustrated). The transmission 52 shifts the driving force transmitted from the engine 1 through an odd-number gear stage or an even-number gear stage. The shifted driving force is transmitted to driving wheels 56 via an output shaft 53 of the transmission 52, a differential gear mechanism 54, and a drive shaft 55, and the vehicle V is driven by means of the transmitted driving force.

A driving device of the vehicle V configured as described above has driving modes such as an engine driving mode in which the vehicle V is driven by only the engine 1 serving as a driving source (hereinafter, will be referred to as “ENG mode”), a motor driving mode in which the vehicle V is driven by only the motor 61 serving as another driving source in a state in which two clutches of the transmission 52 are disconnected (hereinafter, will be referred to as “EV mode”), and a hybrid driving mode in which the vehicle V is driven by both the engine 1 and the motor 61 serving as the driving sources (hereinafter, will be referred to as “HEV mode”).

In addition, in the ENG mode, when predetermined automatic stop conditions are satisfied, the engine 1 is brought to an automatic stop (hereinafter, will be referred to as “idling stop”). Moreover, when predetermined restart conditions are satisfied after this automatic stop state, idling stop control is performed to automatically restart the engine 1. The automatic stop conditions are satisfied when fulfilling all conditions that the speed of the vehicle V is equal to or lower than a predetermined speed, an accelerator pedal (not illustrated) is not stepped on, a brake pedal (not illustrated) is stepped on, the state-of-charge (SOC) of the high-voltage battery 63 is equal to or higher than a predetermined amount, the temperature of a coolant for the engine 1 is equal to or higher than a predetermined temperature, the engine 1 is completely warmed up, and the like.

As illustrated in FIG. 2, for example, the engine 1 is a direct-injection engine which has four cylinders 6 arranged in series and in which fuel is directly injected into combustion chambers (not illustrated) of the cylinders 6. Each of the cylinders 6 is provided with a fuel injection valve 7, an ignition plug 8, and an intake valve and an exhaust valve (neither is illustrated).

In addition, the engine 1 includes an intake passage 2, an exhaust passage 10, and a turbocharger 12 serving as a supercharger. The intake passage 2 is connected to a surge tank 4, and the surge tank 4 is connected to each of the combustion chambers of the cylinders 6 respectively via intake manifolds 5. The intake passage 2 is provided with a compressor 123 of the turbocharger 12 (will be described below), an intercooler 3 for cooling air added by the turbocharger 12, and a throttle valve 13, in this order from the upstream side. The throttle valve 13 is driven by a throttle (TH) actuator 13a. The surge tank 4 is provided with an intake pressure sensor 21 detecting intake pressure PB, and the intake passage 2 is provided with an intake air flow rate sensor 22 detecting an intake air flow rate GAIR.

The turbocharger 12 is provided in the exhaust passage 10 and includes a turbine 121 which is rotatively driven by means of running energy from exhaust gas, and the compressor 123 which is provided in the intake passage 2 and is coupled to the turbine 121 via a shaft 122. The compressor 123 pressurizes air (intake air) taken into the engine 1, thereby performing supercharging. A bypass passage 16 bypassing the compressor 123 is connected to the intake passage 2. The bypass passage 16 is provided with an air bypass valve (hereinafter, will be referred to as “AB valve”) 17 for regulating the flow rate of air passing through the bypass passage 16.

The exhaust passage 10 is connected to each of the combustion chambers of the cylinders 6 via exhaust manifolds 9. A bypass passage 11 bypassing the turbine 121 is connected to the exhaust passage 10. A connection portion of the bypass passage 11 on the downstream side is provided with a waste gate valve (hereinafter, will be referred to as “WG valve”) 14 for regulating the flow rate of exhaust gas passing through the bypass passage 11. In addition, the engine 1 is provided with a known exhaust-gas recirculation (EGR) device (not illustrated) for causing a part of exhaust gas discharged from the combustion chambers to the exhaust passage 10 to recirculate into the intake passage 2.

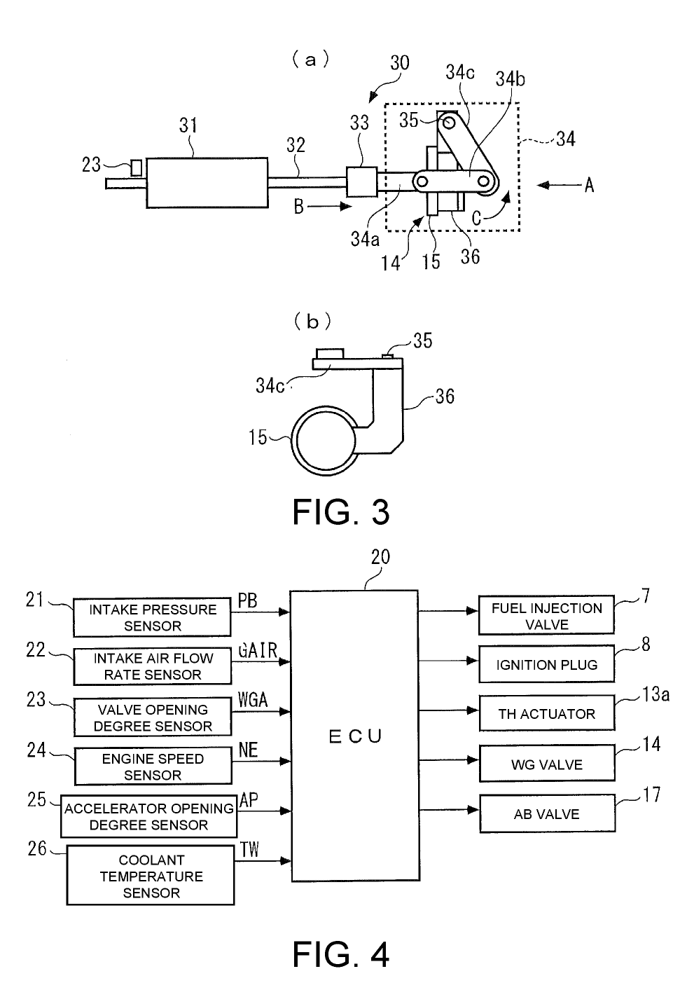

As illustrated in FIG. 3, a driving mechanism 30 driving the WG valve 14 includes a motor 31 serving as an actuator, a rod 32, a heat shielding member 33, and a link mechanism 34 coupled to a valve body 15 of the WG valve 14. For example, the motor 31 is configured to be a DC motor. Under the control of the ECU 20, the motor 31 switches between the normal rotation and the reverse rotation in accordance with the orientation of electrification, and the torque of the motor 31 is controlled in accordance with a duty ratio (hereinafter, will be referred to as “electrification duty ratio”) Iduty of a driving pulse for electrification.

In addition, a female screw (not illustrated) is formed in a rotor of the motor 31, and a male screw screwed into the female screw is formed in the rod 32. Due to this configuration, rotation of the motor 31 is converted into linear motion of the rod 32, so that the rod 32 moves to the right or to the left in FIG. 3 in accordance with the rotation direction of the motor 31.

The link mechanism 34 includes a coupling member 34a which is coupled to the rod 32 via the heat shielding member 33, and a first link material 34b and a second link material 34c which are subjected to pin-connection with respect to the coupling member 34a in this order. The second link material 34c is rotatably supported by a rotary shaft 35. In addition, a holding member 36 is integrally provided in the second link material 34c, and the valve body 15 of the WG valve 14 is integrally held by the holding member 36 (refer to FIG. 3(b)).

FIG. 3(a) illustrates a valve closed state of the WG valve 14, that is, a state in which the WG valve 14 is blocking the bypass passage 11. From this valve closed state, when the motor 31 is electrified with a current toward a predetermined orientation, the motor 31 is rotatively driven in a predetermined direction in response to the electrification, and the rod 32 screwed to the rotor thereof moves in an arrow B direction in FIG. 3. Consequently, the second link material 34c of the link mechanism 34, and the holding member 36 and the valve body 15 which are integrated with the second link material 34c turn in an arrow C direction about the rotary shaft 35, thereby opening the WG valve 14.

From this valve open state, when the motor 31 is electrified with a current toward a reverse orientation thereof, the motor 31 is rotatively driven in the reverse direction, and the rod 32 moves in a direction opposite to the arrow B. Consequently, the link mechanism 34 is operated in the reverse direction thereof. Then, the second link material 34c, the holding member 36, and the valve body 15 turn a direction opposite to the arrow C, and the WG valve 14 returns to the valve closed state. Hereinafter, the electrification duty ratio Iduty of when the WG valve 14 is driven to the valve open side as described above will be defined as “positive”, and the electrification duty ratio Iduty of when the WG valve 14 is driven to the valve closed side will be defined as “negative”.

Therefore, when the electrification duty ratio Iduty is negative, the WG valve 14 is driven toward a fully-closed position. The greater the absolute value thereof, the stronger the force pressing the valve body 15 to a valve seat (not illustrated) at the time of opening the valve. In addition, since the rotor of the motor 31 is screwed to the rod 32, the electrification duty ratio Iduty becomes zero, and when the motor 31 stops rotating, the WG valve 14 maintains the opening degree at the time of the stop.

In addition, a valve opening degree sensor 23 is provided in an end portion of the rod 32 on a side opposite to the valve body 15. The valve opening degree sensor 23 detects a position of the rod 32 in an axial line direction (arrow B direction), thereby detecting an opening degree (hereinafter, will be referred to as “detected opening degree”) WGA of the WG valve 14. A driving mechanism (not illustrated) of the AB valve 17 is also configured in a similar manner, and this driving mechanism includes a motor for driving the AB valve 17 such that the AB valve 17 is opened or closed, and a valve opening degree sensor for detecting the opening degree of the AB valve 17.

FIG. 4 illustrates a configuration of the control device for an engine 1. In addition to the intake pressure sensor 21, the intake air flow rate sensor 22, and the valve opening degree sensor 23, an engine speed sensor 24 detecting an engine speed (hereinafter, will be referred to as “engine speed”) NE of the engine 1, an accelerator opening degree sensor 25 detecting an operation amount (hereinafter, will be referred to as “accelerator opening degree”) AP of the accelerator pedal of the vehicle V, a coolant temperature sensor 26 detecting a temperature (hereinafter, will be referred to as “engine coolant temperature”) TW of the coolant for the engine 1, and the like are connected to the ECU 20. Detection signals thereof are input to the ECU 20. The fuel injection valve 7, the ignition plug 8, the TH actuator 13a, the WG valve 14 (motor 31), and the AB valve 17 (motor) are connected to an output side of the ECU 20.

The ECU 20 is configured to be a microcomputer constituted by a CPU, a RAM, a ROM, and an input interface (none are illustrated). The ECU 20 determines the above-described driving mode (ENG mode, HEV mode, or EV mode) of the vehicle V in accordance with the detection signals or the like of the various sensors 21 to 26 described above and controls the engine 1 and the motor 61 in accordance with the determined driving mode. The above-described idling stop control is executed in the ENG mode.

In addition, as control over the engine, the ECU 20 performs fuel injection control for the fuel injection valve 7, ignition control for the ignition plug 8, intake air amount control for the throttle valve 13, supercharging pressure control for the WG valve 14, and the like in accordance with the running state (mainly, engine speed NE and required torque TRQD) of the engine 1. The required torque TRQD is calculated in accordance with mainly the accelerator opening degree AP so as to be greater when the accelerator opening degree AP increases. In the embodiment, the ECU 20 corresponds to a target opening degree setting unit, a control unit, and a fully-closed position learning unit.

In the supercharging pressure control, a target opening degree WGCMD of the WG valve 14 is set in accordance with the running state and the like of the engine 1, and electrification of the motor 31 is controlled such that the opening degree detected by the valve opening degree sensor 23 coincides with the target opening degree WGCMD. Therefore, in order to make an actual opening degree of the WG valve 14 precisely coincide with the target opening degree WGCMD and to obtain desired supercharging pressure with more accuracy, there is a need to enhance the accuracy of the opening degree detected by the valve opening degree sensor 23.

Meanwhile, as described above, the valve opening degree sensor 23 does not directly detect the opening degree of the valve body 15 of the WG valve 14. The valve opening degree sensor 23 is configured to indirectly obtain the detected opening degree WGA via the position in the axial line direction of the rod 32 which is coupled to the valve body 15 via the driving mechanism 30. Therefore, the detected opening degree WGA detected by the valve opening degree sensor 23 includes many kinds of errors due to various factors including errors caused due to aging such as abrasion of configuration components of the driving mechanism 30, and temperature-dependent errors depending on the temperatures of the configuration components, the rod 32, and the like of the driving mechanism 30.

In order to eliminate such errors as much as possible, in the present embodiment, learning of the fully-closed position of the WG valve 14 is performed in a timely manner. Specifically, when the valve body 15 reaches the fully-closed position, the detected opening degree WGA detected by the valve opening degree sensor 23 is learned and stored as a fully-closed opening degree learning value WGFC. Thereafter, a value obtained by subtracting the fully-closed opening degree learning value WGFC from the detected opening degree WGA detected by the valve opening degree sensor 23 is calculated as an opening degree (hereinafter, will be referred to as “valve opening degree”) WGO of the WG valve 14. In control over the opening degree of the WG valve 14 described below, the valve opening degree WGO learned and corrected as described above is employed.

Learning of the fully-closed position of the WG valve 14 is executed as low-temperature period learning immediately after an ignition switch is turned on, and learning thereof is executed as running period learning at the timing when the WG valve 14 is controlled such that the WG valve 14 is at the fully-closed position while the engine 1 is running (ENG mode). Moreover, as described below, learning thereof is executed as stop period learning in a state in which the engine 1 is at a stop state (during EV mode and idling stop).

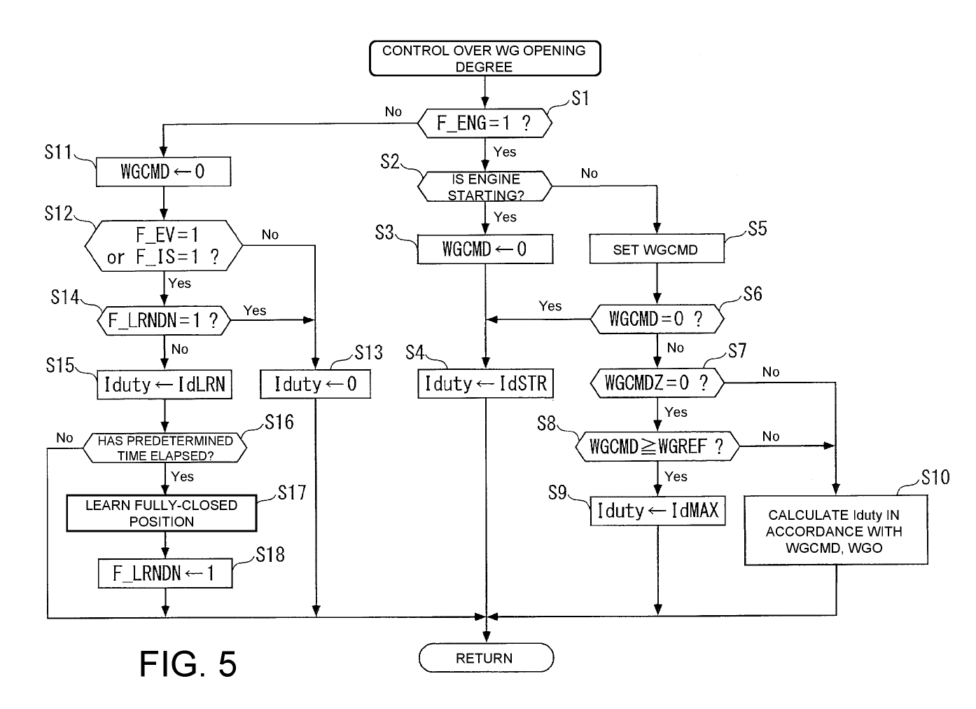

FIG. 5 is a flowchart of processing of executing control over an opening degree of the WG valve 14. This processing is repetitively executed by the ECU 20 at predetermined times.

In this processing, first, in Step 1 (illustrated as “S1”, hereinafter, the same will apply), the ECU 20 verifies whether or not an ENG mode flag F_ENG is “1”. When the answer is YES and the current driving mode of the vehicle V is the ENG mode, the ECU 20 determines whether or not the engine 1 is starting (Step 2). In this determination, when the engine speed NE has not yet reached a predetermined idling engine speed (start-up engine speed) after an operation of starting the engine 1 has begun, the ECU 20 determines that the engine 1 is starting.

When the answer to this determination in Step 2 is YES and the engine 1 is starting, the target opening degree WGCMD of the WG valve 14 is set to zero (Step 3), and the electrification duty ratio Iduty of the motor 31 is set to a predetermined negative value IdSTR (for example, −5%) slightly smaller than the value of zero (Step 4), thereby ending this processing. Accordingly, while the engine 1 is starting, the WG valve 14 is maintained at a valve closed position in a state in which the valve body 15 thereof is pressed to the valve seat by a relatively small force.

Meanwhile, when the engine 1 is not starting, the target opening degree WGCMD of the WG valve 14 is set in Step 5. The target opening degree WGCMD is set by searching for a predetermined map (not illustrated) in accordance with the running state of the engine 1, for example, the required torque TRQD and the engine speed NE. Next, the ECU 20 verifies whether or not the set target opening degree WGCMD is zero (Step 6). When the answer is YES, the foregoing Step 4 is executed. Thereafter, this processing ends. In this manner, in the running state after the engine 1 has started, when the target opening degree WGCMD is set to zero, the electrification duty ratio Iduty is set to the predetermined value IdSTR similar to when the engine 1 is starting.

When the answer in Step 6 is NO and the target opening degree WGCMD is not zero, the ECU 20 verifies whether or not a previous target opening degree WGCMDZ was zero (Step 7). When the answer to this determination is YES, that is, when a current processing cycle corresponds to first timing at which the WG valve 14 is opened from the fully-closed position, the ECU 20 verifies whether or not the target opening degree WGCMD is equal to or greater than a predetermined threshold value WGREF (Step 8).

When the answer to this determination is YES and the target opening degree WGCMD is relatively large, the electrification duty ratio Iduty is set to the predetermined maximum positive value IdMAX (for example, 100%) (Step 9), thereby ending this processing. In this manner, when the WG valve 14 is opened from the fully-closed position toward the target opening degree WGCMD which is relatively large, the electrification duty ratio Iduty is set to the predetermined maximum value IdMAX by means of feedforward control, without depending on ordinary feedback control, which will be described below.

When the answer in Step 8 is NO and the target opening degree WGCMD is relatively small, or when the answer in Step 7 is NO and it is not the first timing at which the WG valve 14 is opened from the fully-closed position, the electrification duty ratio Iduty is calculated in Step 10, thereby ending this processing. The electrification duty ratio Iduty is calculated by means of the feedback control (for example, PID control) such that the valve opening degree WGO of the WG valve 14 calculated as described above reaches the target opening degree WGCMD.

Meanwhile, when the answer in Step 10 is NO and the driving mode is not the ENG mode, the target opening degree WGCMD is set to zero (Step 11). Next, the ECU 20 verifies whether or not an EV mode flag F_EV or an idling stop flag F IS is “1” (Step 12). When the answer to this determination is NO, and the driving mode of the vehicle V is neither the EV mode nor the idling stop, for example, when the vehicle V is in a stop state in which the ignition switch is turned off, the electrification duty ratio Iduty is set to zero (Step 13), thereby ending this processing.

When the answer in Step 12 is YES and the driving mode is the EV mode or an idling stop, the ECU 20 verifies whether or not a learning completion flag F_LRNDN is “1” (Step 14). As described below, this learning completion flag F_LRNDN is set to “1” when the fully-closed position learning of the WG valve 14 executed while the driving mode is the EV mode or an idling stop is completed. When the answer to this determination in Step 14 is NO and the fully-closed position learning is not completed, the electrification duty ratio Iduty is set to a predetermined negative value IdLRN for learning (for example, −50%) considerably smaller than the value of zero (having a large absolute value) (Step 15). Accordingly, the WG valve 14 is reliably maintained at the valve closed position in a state in which the valve body 15 is strongly pressed to the valve seat.

Next, as described above, after the electrification duty ratio Iduty is set to the predetermined value IdLRN for learning, the ECU 20 verifies whether or not a predetermined time has elapsed (Step 16). When the predetermined time has not elapsed, this processing ends with no change. When the predetermined time has elapsed, the valve closed position of the WG valve 14 is learned (Step 17). In order to indicate that the learning has been completed, the learning completion flag F_LRNDN is set to “1” (Step 18), thereby ending this processing.

After Step 18 has been executed, the answer in Step 14 becomes YES. In such a case, the processing proceeds to Step 13, and the electrification duty ratio Iduty is set to zero. As described above, when the driving mode shifts to the EV mode or an idling stop, the electrification duty ratio Iduty is set to the predetermined value IdLRN for learning. Accordingly, the WG valve 14 is forcibly driven to the fully-closed position, and the fully-closed position is learned. Moreover, after the learning is completed, the electrification duty ratio Iduty is controlled such that the electrification duty ratio Iduty becomes zero, and electrification of the motor 31 stops.

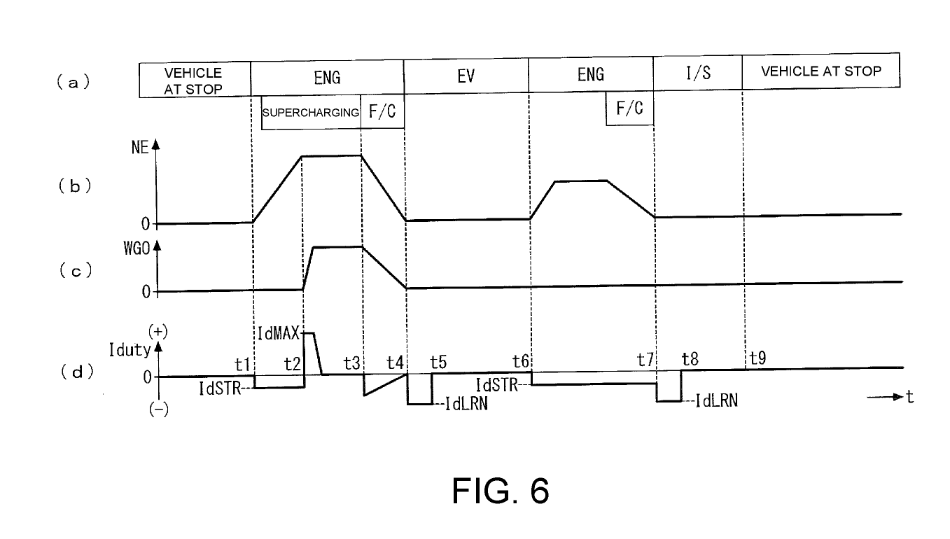

Next, with reference to FIG. 6, an operational example obtained by means of control over the above-described opening degree of the WG valve 14 in FIG. 5 will be described. FIGS. 6(a) to 6(d) respectively illustrate a running state including the driving mode of the vehicle V, the engine speed NE, the valve opening degree WGO of the WG valve 14, and transition of the electrification duty ratio Iduty.

When the ignition switch and a starter switch are turned on at the time t1 from a state in which the vehicle V is at a stop, starting of the engine 1 begins, and the driving mode shifts to the ENG mode. During this starting, the target opening degree WGCMD is set to zero (Step 3 in FIG. 5), the electrification duty ratio Iduty is set to the predetermined negative value IdSTR (Step 4), and the valve opening degree WGO is maintained at the fully-closed position. Thereafter, starting of the engine 1 ends, and supercharging is performed by the turbocharger 12 in response to an increase of the engine speed NE. In this case, as long as the load on the engine 1 is low and the target opening degree WGCMD is zero (Step 6: YES), similar to when the engine 1 is starting, the electrification duty ratio Iduty is set to the predetermined value IdSTR, and the valve opening degree WGO is maintained at the fully-closed position (t1 to t2).

In order to lower the supercharging pressure, a valve opening operation of the WG valve 14 begins at the time t2. In this example, since the set target opening degree WGCMD is large by being equal to or greater than the threshold value WGREF (Step 8: YES), the electrification duty ratio Iduty is set to the predetermined maximum value IdMAX (Step 9). Thereafter, during supercharge running, and during fuel cut (F/C) running from the time t3, the electrification duty ratio Iduty is calculated by means of the feedback control such that the valve opening degree WGO meets the target opening degree WGCMD (t2 to t4).

When the driving mode shifts to the EV mode at the time t4, the target opening degree WGCMD is set to zero (Step 11). Moreover, immediately after the shift thereto, in a state in which the electrification duty ratio Iduty is set to the predetermined value IdLRN for learning (Step 15), the fully-closed position of the WG valve 14 is learned (Step 17). When the fully-closed position learning is completed at the time t5, the electrification duty ratio Iduty is then set to zero (Step 13), and electrification of the motor 31 stops (t5 to t6).

Thereafter, the driving mode shifts from the EV mode to the ENG mode at the time t6. In this ENG mode, the target opening degree WGCMD is set to zero at all times in the ENG mode, and the WG valve 14 is not opened. Therefore, the electrification duty ratio Iduty is set to the predetermined value IdSTR, and the valve opening degree WGO is maintained at the fully-closed position (t6 to t7).

Idling stop (I/S) begins at the time t7. The operation while being at the idling stop is the same as that in the EV mode. Immediately after the shift thereto, the fully-closed position of the WG valve 14 is learned in a state in which the electrification duty ratio Iduty is set to the predetermined value IdLRN for learning. After the learning thereof is completed (t8), the electrification duty ratio Iduty is set to zero, and electrification of the motor 31 stops (t8 to t9). Thereafter, the ignition switch is turned off at the time t9, so that the vehicle V is in stop state, and the fully-closed position of the WG valve 14 and the electrification stop state of the motor 31 up to that time are maintained.

As described above, according to the present embodiment, while the engine 1 is starting, or while the engine 1 is running in which the target opening degree WGCMD of the WG valve 14 is zero, the electrification duty ratio Iduty of tile motor 31 is set to the predetermined negative value IdSTR slightly smaller than the value of zero. Therefore, the WG valve 14 is reliably maintained at the fully-closed position in a state in which the valve body 15 is pressed to the valve seat by a relatively small force. Accordingly, the WG valve 14 no longer vibrates due to an influence such as vibration of the engine 1 during starting or running. Thus, it is possible to prevent generation of noise and deterioration of the valve body 15 and the like caused due to contact between the valve body 15 thereof and the valve seat. In addition, when sudden acceleration is required from this state, the supercharging pressure can be promptly raised, and satisfactory acceleration responsiveness can be ensured. In addition, since the electrification duty ratio Iduty is set to a small value close to the value of zero, it is possible to suppress consumption of electricity.

In addition, while the driving mode is the EV mode or an idling stop at which the engine 1 is at a stop, the WG valve 14 is driven to the fully-closed position immediately after the shift thereto. Thereafter, the electrification duty ratio Iduty is set to zero, thereby executing electrification stop control in which electrification of the motor 31 stops. In the stop state, the engine 1 does not vibrate. Accordingly, even though electrification of the motor 31 has stopped after the WG valve 14 is driven to the fully-closed position, the WG valve 14 is maintained at the fully-closed position. Therefore, even if the driving mode is the EV mode or an idling stop, the WG valve 14 is prevented from vibrating, and it is possible to prevent generation of noise and deterioration of the valve body 15 and the like caused due to contact between the valve body 15 and the valve seat. In addition, when sudden acceleration is required from this state, the supercharging pressure can be promptly raised, and satisfactory acceleration responsiveness can be ensured. Moreover, since electrification of the motor 31 stops and consumption of electricity during that period becomes zero, in addition to suppressing consumption of electricity in the engine 1 during starting as described above, it is possible to suppress consumption of electricity to a minimum.

In addition, particularly when the engine 1 is in the EV mode, there is a possibility that the WG valve 14 will vibrate due to vibration of the traveling vehicle V and the valve body 15 will come into contact with the valve seat. Meanwhile, since the engine 1 is at a stop, noise caused due to the contact is audible, and thus, the market appeal is likely to be degraded. In the embodiment, since the electrification stop control is executed in the EV mode, generation of noise caused due to contact of the valve body 15 is prevented. Therefore, it is possible to effectively avoid the aforementioned disadvantage and to improve the market appeal. In addition, since electrification of the motor 31 has stopped, it is possible to effectively prevent generation of electromagnetic wave noise which is particularly problematic in the EV mode.

In addition, since the fully-closed position of the WG valve 14 is learned after the WG valve 14 is driven to the fully-closed position while the driving mode is the EV mode or an idling stop, the learning frequency thereof can be increased. In addition, when sudden acceleration is required from the stop state of the engine 1, the opening degree of the waste gate valve can be controlled by utilizing the fully-closed position which has been learned in the immediately preceding learning, and thus, it is possible to control the supercharging pressure with more accuracy.

In addition, the electrification duty ratio Iduty is controlled such that the electrification duty ratio Iduty meets the maximum value IdMAX by means of the feedforward control immediately after a valve opening operation from the fully-closed position of the WG valve 14 has begun. Accordingly, the response delay of when the feedback control is performed is resolved, so that the WG valve 14 is driven to the valve open side more promptly and the valve opening time is shortened. As a result, the increased supercharging pressure drops more promptly, and overshooting of the supercharging pressure exceeding the upper limit value is unlikely to occur. Thus, in accordance therewith, greater supercharging pressure can be set as a target and the output of the engine 1 can be increased. In addition, since the feedforward control is executed when the target opening degree WGCMD is equal to or higher than the threshold value WGREF, it is possible to effectively obtain the above-described effect in a case where a valve opening operation of the WG valve 14 with high responsiveness is required.

The present invention is not limited to the embodiment described above and can be executed in various aspects. For example, in the embodiment, the driving mechanism 30 driving the WG valve 14 is configured to include the motor 31 serving as an actuator, a mechanism converting rotation of the motor 31 into linear motion of the rod 32, the link mechanism 34 opening and closing the valve body 15 in accordance with the reciprocating motion of the rod 32, and the like. However, the basic configuration and the configurations of details of the driving mechanism are arbitrary as long as the waste gate valve is electrically driven. For example, a direct drive motor or an electromagnetic actuator may be employed as the actuator, in place of the rotary motor in the embodiment.

In addition, in the embodiment, the feedforward control for setting the electrification duty ratio Iduty to the maximum value IdMAX when the WG valve 14 is opened from the fully-closed position is performed only once when a valve opening operation begins. However, it is natural that the feedforward control may be performed multiple times.

Moreover, the embodiment illustrates an example of an engine which is mounted in a hybrid vehicle together with an electric motor. However, the present invention is not limited thereto and may be applied to engines for a vehicle having no electric motor. In addition, the present invention can be applied to engines other than engines for a vehicle, for example, engines for a ship propeller such as outboard engines in which a crankshaft is vertically disposed. Furthermore, the configurations of the details can be suitably changed within the scope of the gist of the present invention.

What is claimed is:

1. A control device for an internal combustion engine having a supercharger which supercharges intake air, and a waste gate valve which is provided in a bypass passage bypassing a turbine of the supercharger and regulates supercharging pressure generated by the supercharger, the control device comprising:
an electric actuator that drives the waste gate valve;
target opening degree setting unit for setting a target opening degree of the waste gate valve in accordance with a running state of the internal combustion engine; and
control unit for controlling an opening degree of the waste gate valve by controlling electrification of the actuator,
wherein the control unit controls an electrification amount of the actuator such that the electrification amount meets a predetermined electrification amount allowing the waste gate valve to be pressed to a fully-closed position while the internal combustion engine is starting or in a running state in which the target opening degree is set to a fully-closed opening degree, and the control unit executes electrification stop control for stopping electrification of the actuator after the waste gate valve is driven to the fully-closed position while the internal combustion engine is in a predetermined stop state.

2. The control device for an internal combustion engine according to claim 1,
wherein the internal combustion engine is mounted in a vehicle to serve as a driving source together with an electric motor, and the vehicle has an electric motor driving mode in which the internal combustion engine is at a stop and only the electric motor serves as the driving source, and
wherein the predetermined stop state of the internal combustion engine is a stop state in the electric motor driving mode.

3. The control device for an internal combustion engine according to claim 1, further comprising:
fully-closed position learning unit for learning the fully-closed position of the waste gate valve after the waste gate valve is driven to the fully-closed position and before electrification of the actuator stops during the electrification stop control.

4. The control device for an internal combustion engine according to claim 1, further comprising:
actual opening degree detecting unit for detecting an actual opening degree of the waste gate valve,
wherein the control unit controls the electrification amount of the actuator by feedback control such that the detected actual opening degree meets the target opening degree, and the control unit controls the electrification amount of the actuator such that the electrification amount meets a predetermined maximum value on a side of opening the waste gate valve by feedforward control in place of the feedback control, immediately after a valve opening operation from the fully-closed position of the waste gate valve starts.

5. The control device for an internal combustion engine according to claim 2, further comprising:
fully-closed position learning unit for learning the fully-closed position of the waste gate valve after the waste gate valve is driven to the fully-closed position and before electrification of the actuator stops during the electrification stop control.

6. The control device for an internal combustion engine according to claim 2, further comprising:
actual opening degree detecting unit for detecting an actual opening degree of the waste gate valve,
wherein the control unit controls the electrification amount of the actuator by feedback control such that the detected actual opening degree meets the target opening degree, and the control unit controls the electrification amount of the actuator such that the electrification amount meets a predetermined maximum value on a side of opening the waste gate valve by feedforward control in place of the feedback control, immediately after a valve opening operation from the fully-closed position of the waste gate valve starts.

7. The control device for an internal combustion engine according to claim 3, further comprising:
actual opening degree detecting unit for detecting an actual opening degree of the waste gate valve,
wherein the control unit controls the electrification amount of the actuator by feedback control such that the detected actual opening degree meets the target opening degree, and the control unit controls the electrification amount of the actuator such that the electrification amount meets a predetermined maximum value on a side of opening the waste gate valve by feedforward control in place of the feedback control, immediately after a valve opening operation from the fully-closed position of the waste gate valve starts.

8. The control device for an internal combustion engine according to claim 5, further comprising:
actual opening degree detecting unit for detecting an actual opening degree of the waste gate valve,
wherein the control unit controls the electrification amount of the actuator by feedback control such that the detected actual opening degree meets the target opening degree, and the control unit controls the electrification amount of the actuator such that the electrification amount meets a predetermined maximum value on a side of opening the waste gate valve by feedforward control in place of the feedback control, immediately after a valve opening operation from the fully-closed position of the waste gate valve starts.
